(19) United States
(12) Patent Application Publication
(10) Pub. No.: US 2016/0110749 A1
(43) Pub. Date: Apr. 21, 2016

(54) Method for Directly Issuing and Using Discount Coupon by Product Buyer Himself/Herself

(71) Applicant: Young Hyun SEO, Daegu (KR)

(72) Inventor: Young Hyun Seo, Daegu (KR)

(21) Appl. No.: 14/894,229

(22) PCT Filed: May 26, 2014
(86) PCT No.: PCT/KR2014/004669

§ 371 Date: Nov. 25, 2015

(30) Foreign Application Priority Data
May 27, 2013 (KR) 10-2013-0059418

(51) Int. Cl. G06Q 30/02

(52) U.S. Cl. CPC G06Q 30/0221; G06Q 30/0235

(57) ABSTRACT

The present invention relates to a “method for issuing and using a discount coupon”, in which a product seller can pay a predetermined deposit necessary for issuing the discount coupon to a discount coupon management server having a discount coupon issuing function and a consumer can extemporally issue and use a discount coupon related to a product when purchasing the product. The method comprises the steps of: a) accumulating, by a product seller, a predetermined deposit in the discount coupon management server; and b) accessing the discount coupon management server and issuing a predetermined discount coupon for a product which a product buyer wants to buy, by the product buyer himself/herself, the discount coupon having a predetermined discount price to be discounted within the deposit, wherein at least one predetermined discount coupon is issued within the deposit. Further, when the predetermined discount coupon is used before an expiration date after being issued, the deposit is reduced in proportion to an issue price of the discount coupon. Also, when the predetermined discount coupon is not used before the expiration date after being issued, the deposit is not reduced.

### TECHNICAL FIELD

The present invention relates to a method for directly issuing and using by a product buyer himself/herself, and more particularly, to a method for issuing a discount coupon which can be used by a consumer when purchasing a product offline or online and a method for using the discount coupon. The present invention relates to “a method for issuing and using a discount coupon by a product buyer himself/herself, in which a product seller can pay a predetermined deposit necessary for issuing the discount coupon to a discount coupon management server having a discount coupon issuing function and a consumer can extemporally issue and use a discount coupon related to a product when purchasing the product.

### BACKGROUND ART

Generally, when a consumer purchases a product from an offline or online shopping mall, the consumer may use his/her discount coupons.

Such discount coupons are provided by a product seller, and have been conventionally distributed in the form of a discount coupon brochure or leaflet.

Recently, with the advancement of IT devices such as smart phones or the like and the advent of social commerce as a new form of commerce, there has been widely used a method in which a consumer purchases a discount coupon provided by a product seller and can thus purchase a product offered by the product seller at a lower price.

However, the conventional discount coupon has the following problems.

1. Some consumers who are maliciously issued discount coupons in large quantity and thus inflict damage on a product seller may cause a financial loss of the product seller.

2. A purchase price of a discount coupon is uniformly set to a predetermined price as suggested by a product seller.

3. A specific discount coupon can be used only when purchasing a specific product, but cannot be used when purchasing other products (including products offered by other product sellers).

4. A so-called excellent consumer who frequently purchases a discount coupon is hardly given any additional benefit.

### DISCLOSURE

### Technical Problem

Accordingly, the present invention is suggested to solve the above-described problems, and directed to enabling a discount coupon to be issued within an amount of a deposit made by a product seller and reduction of the deposit to be finally calculated only when the issued discount coupon is actually used for product purchase, in order to issue and use discount coupons mainly for real consumers.

### Technical Solution

One aspect of the present invention provides a method for issuing and using a discount coupon with a discount coupon management server having a function of generating a discount coupon corresponding to a deposit made by a product seller who wants to sell a product and providing the discount coupon to a product buyer, the method including:

(a) accumulating, by the product seller, a predetermined deposit in the discount coupon management server; and

(b) accessing the discount coupon management server and issuing a discount coupon having a predetermined discount price for a product which the product buyer wants to purchase within the range of the deposit, by the product buyer himself/herself,

wherein at least one predetermined discount coupon having the predetermined discount price is issued within an amount of the deposit,

when the predetermined discount coupon is used within a term of validity after being issued, the deposit is reduced in proportion to an issue price of the discount coupon, and

when the predetermined discount coupon is not used within the term of validity after being issued, the deposit is not reduced.

In the present invention, the issue price of the discount coupon may be changed according to a discount coupon usage result of the product buyer.

In the present invention, if the discount coupon issued several times by the product buyer is not used within a predetermined time period, issuance of the discount coupon is blocked for a predetermined time period.

In the present invention, the discount coupon issued by the product buyer includes information of a product manager and information of the product buyer.

In the present invention, a predetermined amount of reserve is accumulated in an account of the product buyer according to an issuance result of the discount coupon of the product buyer.

In the present invention, the reserve accumulated in the account of the product buyer can be used at the time of purchasing a product from at least one online shopping mall interworking with the discount coupon management server.

In the present invention, the discount coupon issued by the product buyer can be transmitted to a portable terminal of a third person and transferred to the third person. If the third person uses the discount coupon, such use may be reflected on a purchase result of the product buyer.

In the present invention, the discount coupon transmitted to the portable terminal of the third person includes a bar code or QR code.

### Advantageous Effects

The present invention can be applied to both of online and offline shops and may be of advantage to both of a product seller and a product buyer as follows.

As for the product seller, a deposit of the product seller is reduced when a discount coupon is issued. However, if the discount coupon is not used within a term of validity, the deposit is recovered.

Therefore, it is possible to prevent a malicious product buyer from issuing discount coupons in large quantity.

The product buyer can purchase a product, which the product buyer wants to buy, at a price lower than a list price, which is of economic advantage to the product buyer. Further, the product buyer is given additional benefits, such as being able to issue a discount coupon at a price lower than a predetermined discount price, according to an issuance result or usage result of the discount coupon, and, thus, can be a main customer of the present system.

### DESCRIPTION OF DRAWINGS

FIG. 1 illustrates a basic system for implementing the present invention.

### MODES OF THE INVENTION

Hereinafter, exemplary embodiments of the present invention will be described in detail with reference to the accompanying drawings. It should be noted that the same elements in the drawings will be designated by the same reference numerals, wherever possible. Further, detailed description of well-known functions or structures will be omitted when it is deemed that such description will cause ambiguous interpretation of the present invention.

Above all, the terms used herein will be defined.

Discount coupon management server: a supervisory server at which a product seller (an individual or a company) registers itself as a member and by which the product seller registers and manages at least one product, which the product seller wants to sell, at a site directly operated by the discount coupon management server or a site interworking with the discount coupon management server, and the product seller needs to pay a predetermined deposit (by online payment) to the discount coupon management server.

Product buyer: a consumer who wants to purchase a product.

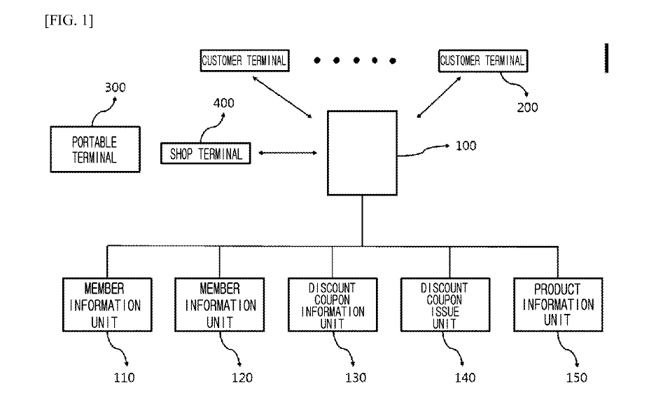

Hereinafter, a system as a prerequisite for the present invention will be schematically described with reference to FIG. 1.

FIG. 1 illustrates a basic system for implementing the present invention.

In FIG. 1, a product seller or a product buyer may implement the present invention described below after registering himself/herself as a member of a discount coupon management server 100 through a terminal 200, and if a discount coupon is transmitted to a portable terminal 300, the present invention may be implemented through a shop terminal 400 installed at an offline shop in the same manner as implemented online, which will be described below.

Hereinafter, characters of a deposit according to the present invention to be implemented on the basis of the basic system and a process in which a product buyer accesses a discount coupon management server and directly issues a discount coupon for a product, which the product buyer wants to buy, within an amount of a deposit will be described.

[Discount Coupon Issuance Deposit]

Firstly, the product seller needs to make a predetermined deposit into an account stored in a discount coupon management server operator according to the agreement.

The deposit can be made in various ways.

The product seller accesses a site managed by the discount coupon management server through his/her terminal such as a smart phone or a computer.

Then, the product seller performs login (through member registration).

Then, when the predetermined deposit is paid, information thereof is stored in a deposit management module of the discount coupon management server.

[Issuance of Discount Coupon]

Next, issuance of a discount coupon according to the present invention is characterized in that the product buyer directly issues and uses the discount coupon. Details thereof will be described hereinafter.

Firstly, the product buyer accesses a site interworking with the discount coupon management server and selects a product which the product buyer wants to buy.

When a product is selected, if information indicating that a discount coupon can be issued is disclosed, the product buyer may follow a predetermined procedure for issuing the discount coupon.

If the product buyer starts issuing the discount coupon, the discount coupon management server checks the deposit in the deposit management module.

If the deposit is sufficient to issue a discount coupon having a predetermined price, the product buyer issues the discount coupon having a predetermined price.

If the discount coupon is issued at the predetermined price, the deposit in the deposit management module is reduced as much as the amount of money for issuance.

Meanwhile, if the deposit is not sufficient to issue the discount coupon having a predetermined price, the product buyer cannot issue the discount coupon.

[Limitation in Number of Times of Issuing Discount Coupon]

In the present invention, if a specific product buyer issues too many discount coupons within a predetermined time period, “the discount coupon issuance deposit” may be insufficient. In this case, many other consumers cannot be given a benefit of the discount coupon.

Accordingly, in the present invention, each product buyer is limited in the number of times of issuing a discount coupon in order to prevent issuance of too many discount coupons by a specific product buyer.

The limitation may be determined according to the agreement (regulations) of the discount coupon management server (service manager).

Such a limitation process will be described as follows.

Firstly, if a specific product buyer starts issuing a discount coupon, the discount coupon management server searches for information about issuance of discount coupons of the product buyer.

Then, if the number of times of issuing a discount coupon by the product buyer exceeds a predetermined number of times of issuing a discount coupon as prescribed in the service agreement, the product buyer may be notified by a pop-up window of a message indicating that the discount coupon can be issued after a predetermined time period.

Meanwhile, in the present invention, in order to prevent overissue of discount coupons by a malicious member (product buyer), the number of times of issuing a discount coupon may be limited according to records of issuing and using discount coupons.

[Setting of Issue Price and Issuability of Discount Coupon]

If the product buyer issues and uses a discount coupon when purchasing a product, the product seller has a decreased profit margin on product sales.

In the present invention, to solve this problem, products on sale are classified by kind into whether or not a discount coupon can be issued, and then set in a “discount coupon issuable product information module” of the discount coupon management server.

In the present invention, the products stored in the “discount coupon issuable product information module” can be changed any time by the product buyer.

Meanwhile, information about how to determine a price of a discount coupon to be issued for a discount coupon issuable product among the products stored in the “discount coupon issuable product information module” may be included.

For example, information about whether a predetermined discount rate or a predetermined discount price is applied to a price of a product which the product buyer wants to buy may be included.

To be specific, when the product seller accesses the discount coupon management server and registers a product for sale, the product seller may set a discount rate or discount price of a discount coupon to be used at the time of issuance of a discount coupon relevant to the product.

Further, the product seller may set whether or not a specific product is a discount coupon issuable product. [Setting of Discount Rate or Discount Price at the Time of Issuance of Discount Coupon]

In the present invention, at the time of issuance of a discount coupon, a discount coupon having a predetermined discount rate (%) to be applied to a price of a purchased product may be issued, or a discount coupon having a predetermined price (fixed price) may be issued.

Further, in the present invention, discount coupons for one or more coupons may be issued sequentially or concurrently.

[Application of a Higher Discount Rate or Discount Price of Discount Coupon]

Conventionally, a discount rate or discount price of a discount coupon is determined by the product seller.

For this reason, all of the product buyers use discount coupons having the same discount rate or discount price.

However, in the present invention, as for an excellent product buyer who purchases a large quantity of products offered by a specific product seller, if a purchase quantity exceeds a predetermined reference quantity, a discount coupon may be issued at a price lower than a predetermined discount coupon issue price.

[Issuance of Discount Coupon in Proportion to Total Purchase Amount (Total Purchase Quantity) For Product]

In the present invention, a discount coupon may be issued for each product. However, if the total purchase amount (total purchase quantity) of the product buyer exceeds a predetermined reference level, a discount coupon for general purpose may be issued in proportion to a purchase amount.

This is one of benefits given to the excellent product buyer.

[Term of Validity of Issued Discount Coupon]

In the present invention, a term of validity of a discount coupon issued by the product buyer is set.

That is, the discount coupon of the present invention may include information of a term of validity in addition to the information of the product seller and buyer.

In the present invention, if there is a discount coupon which is issued but not used within a term of validity, a deposit reduced for issuance of the discount coupon is recovered.

Therefore, the product seller can sell products mainly to real consumers.

A process therefor may be performed in various ways. For example, if a discount coupon is used after expiration of a term of validity, the discount coupon management server may check this discount coupon and post a message indicating that the discount coupon cannot be used due to expiration of the validity term, or may delete information about a discount coupon which is not used within a term of validity.

Meanwhile, in the present invention, the product buyer may be provided with a predetermined amount of cash in the form of reserve according to the quantity of discount coupons or number of times of issuing a discount coupon. The reserve is accumulated as cash which can be readily used for purchase of a product from another product seller (a third product seller).

Further, a discount coupon suggested in the present invention can be sold or transferred to a third person. A right to use can be transferred by transmitting the discount coupon to a portable terminal of the third person.

The present invention can be applied to both of online and offline shops and may be of advantage to both of a product seller and a product buyer as follows.

[Advantage to Product Seller]

As for the product seller, a deposit of the product seller is reduced when a discount coupon is issued. However, if the discount coupon is not used within a term of validity, the deposit is recovered.

Therefore, it is possible to prevent a malicious product buyer from issuing discount coupons in large quantity.

[Advantage to Product Buyer]

The product buyer can purchase a product, which the product buyer wants to buy, at a price lower than a list price, which is of economic advantage to the product buyer.

Further, the product buyer is given additional benefits, such as being able to issue a discount coupon at a price lower than a predetermined discount price, according to an issuance result or usage result of the discount coupon, and, thus, can be a main customer of the present system.

Although it has been mainly described that the present invention is used online, a discount coupon can be downloaded into a portable terminal and used in an offline shop, and the same applies in the case where the discount coupon is transmitted to a portable terminal of a third person.

The present invention has been described above with reference to the exemplary embodiments, but can be changed or modified in various ways without departing from the scope of the present invention. Therefore, the scope of the present invention is not defined by the above-described exemplary embodiments, but defined by the following claim and the equivalents thereto.

1. A method for directly issuing and using a discount coupon by a product buyer himself/herself with a discount coupon management server having a function that enables the product buyer to directly issue and use a discount coupon corresponding to a deposit made by a product seller who wants to sell a product, the method comprising:
(a) accumulating, by the product seller, a predetermined deposit in the discount coupon management server with his/her terminal interworking with the discount coupon management server; and
(b) accessing the discount coupon management server through the product buyer's terminal interworking with the discount coupon management server, issuing a discount coupon having a predetermined discount price for a product, which the product buyer wants to purchase, within an amount of the deposit, and storing the discount coupon in the discount coupon management server, by the product buyer himself/herself,
wherein at least one predetermined discount coupon having the predetermined discount price is issued through the terminal of the product buyer within the amount of the deposit,
when the predetermined discount coupon is used within a term of validity after being issued, the deposit is reduced in proportion to an issue price of the discount coupon,
when the predetermined discount coupon is not used within the term of validity after being issued, the deposit is not reduced,
when the product buyer does not use the discount coupon issued through his/her terminal within a predetermined time period, further issuance of the discount coupon is blocked for a predetermined time period,
a predetermined amount of reserve, which is changed according to an issuance result and a usage result of the discount coupon of the product buyer, is accumulated in an account of the product buyer,
the reserve accumulated in the account of the product buyer can be used at the time of purchasing a product from at least one online shopping mall interworking with the discount coupon management server,
the discount coupon issued by the product buyer includes information of a product manager and information of the product buyer,
the discount coupon issued by the product buyer and including the information of the product buyer can be transmitted to a portable terminal of a third person and transferred to the third person, and
when the third person uses the discount coupon, such use is reflected on a purchase result of the product buyer.
